(19) United States
(12) Patent Application Publication
(10) Pub. No.: US 2012/0181228 A1
(43) Pub. Date: Jul. 19, 2012

(54) Polyacrylonitrile Copolymer, Method For Manufacturing Membrane Including The Same, Membrane Including The Same, And Water Treatment Module Using The Membrane

(75) Inventors: Hyo Kang, Seoul (KR); Jung Im Han, Yongin-si (KR); Sung Soo Han, Hwaseong-si (KR); Hyo Rang Kang, Anyang-si (KR)

(73) Assignee: SAMSUNG ELECTRONICS CO., LTD., Suwon-si (KR)

(21) Appl. No.: 13/242,317

(22) Filed: Sep. 23, 2011

(30) Foreign Application Priority Data
Jan. 18, 2011 (KR) 10-2011-0004979

(51) Int. Cl. B01D 71/68; C08F 216/16; B05D 5/00; B05D 7/24; B05D 3/00; C08F 214/14; C08F 220/44

(52) U.S. Cl. 210/490; 526/293; 526/333; 526/342; 427/331; 427/243

(57) ABSTRACT

Example embodiments relate to a polyacrylonitrile-based copolymer, a method for manufacturing a membrane including the same, a membrane including the same, and a water treatment module using the same. A membrane according to an example embodiment may include a polyacrylonitrile-based copolymer including a repeating unit represented by Chemical Formula 1, a repeating unit represented by Chemical Formula 2, and/or a repeating unit represented by Chemical Formula 3. The definitions of the above Chemical Formulae 1, 2, and/or 3 may be the same as in the detailed description. Accordingly, the membrane may allow the attainment of a relatively high water permeation amount and a water treatment module having a relatively high energy efficiency.

### CROSS-REFERENCE TO RELATED APPLICATION

This application claims priority under 35 U.S.C. §119 to Korean Patent Application No. 10-2011-0004979, filed in the Korean Intellectual Property Office on Jan. 18, 2011, the entire contents of which are incorporated herein by reference.

### BACKGROUND

1. Field

Example embodiments relate to a polyacrylonitrile-based copolymer, a method for manufacturing a membrane including the same, a membrane including the same, and a water treatment module using the membrane.

2. Description of the Related Art

To acquire fresh water or gray water from sea water or sewage and waste water, floating or dissolved components should be removed in conformity with the standards for drinking water. At present, reverse osmosis is commonly used as a water treatment method for desalinating or making gray water out of sea water or sewage and waste water.

According to a water treatment method using a reverse osmotic membrane, a pressure corresponding to an osmotic pressure caused by the dissolved component is applied to the raw water to separate the dissolved component, such as a base (NaCl), from the water. For example, the concentration of the base dissolved in sea water may range from about 30,000 to about 45,000 ppm, and the osmotic pressure caused from the concentration may range from about 20 to about 30 atm. As a result, a pressure of about 20 to about 30 atm or higher may be applied to the raw water to produce fresh water from the raw water. Typically, an amount of energy of about 6 to about 10 kW/m³ is required to produce about 1 m³ of fresh water from sea water.

An energy recollection device has been developed and applied to save the amount of energy consumed in a reverse osmosis process. However, in such a case, about 3 kW/m³ of energy is required to drive a motor of a high-pressure pump.

To resolve the energy problem, a water treatment process based on forward osmosis has been suggested as an alternative. A forward osmosis process is economical compared to a reverse osmosis process, because the forward osmosis process does not require pressure but uses a natural osmosis phenomenon.

To apply a forward osmosis process for the purpose of desalinating sea water, a forward osmotic membrane may be developed in the form of a composite membrane. Also, to increase the amount of water permeation, it is important to design a support layer for forward osmosis to have a relatively high water permeability in an osmotic direction and to design a solute of an inducing solution to not be diffused toward reverse osmosis. To this end, the support layer is formed of a hydrophilic membrane material.

In the structure of a conventional composite membrane formed of a polyamide, a polysulfone is used as a support layer, and the composite membrane is specialized for a reverse osmotic system. When it is applied to a forward osmotic system, it is known to have a relatively low production flow rate of about 2 gallon/ft² (gfd) or lower under the osmotic pressure condition of about 70 atm (raw water:pure water, inducing solution: 1.5 M NaCl).

To ensure a relatively high water permeation of a forward osmotic membrane, it may be beneficial to develop a hydrophilic material for the support layer that may substitute for a polysulfone. A support layer, such as polyacrylonitrile, has been suggested as an alternative.

However, when polyacrylonitrile is used as a support layer, it is relatively difficult to control the wettability when it forms a composite membrane with a membrane such as a polyamide. As a result, it is also relatively difficult to secure interface uniformity. Consequently, when the interface is a non-uniform composite membrane, there may be a problem in the amount of water permeation.

### SUMMARY

Various embodiments of the disclosure relate to a polyacrylonitrile-based copolymer that is applicable to a membrane.

Various embodiments of the disclosure relate to a method of manufacturing a membrane including the polyacrylonitrile-based copolymer.

Various embodiments of the disclosure relate a membrane including the polyacrylonitrile-based copolymer.

Various embodiments of the disclosure relate to a water treatment module using the membrane.

According to one non-limiting embodiment of the disclosure, a polyacrylonitrile-based copolymer may include a repeating unit represented by the following Chemical Formula 1, a repeating unit represented by the following Chemical Formula 2, and/or a repeating unit represented by the following Chemical Formula 3.

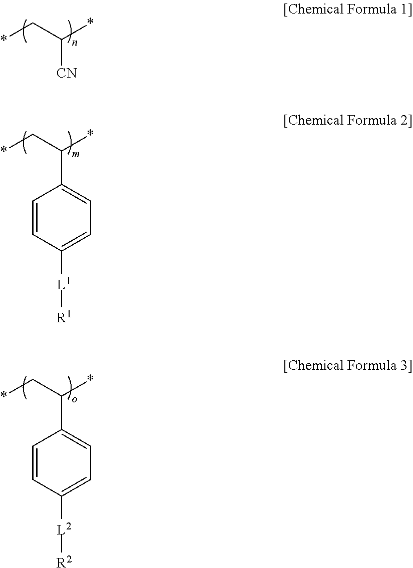

In Chemical Formulae 1 to 3, n/(n+m+o) may range from 0.5 to 0.99 and (m+o)/(n+m+o) may range from 0.01 to 0.5, L¹ and L² may be the same or different and are each independently —CR′R″—, —NR′—, —S—, —SO₂—, —O—, —C(O)O—, —NR′C(O)—, or a combination thereof, R′ and R″ may be the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, R¹ may be a hydrophilic or hydrophobic substituent, and R² may be a hydrophilic or hydrophobic substituent.

The copolymer may have a weight average molecular weight of about 10,000 to about 200,000.

The copolymer may have a polydispersity of about 1.0 to about 10.0.

The copolymer may include a repeating unit represented by the following Chemical Formula 4.

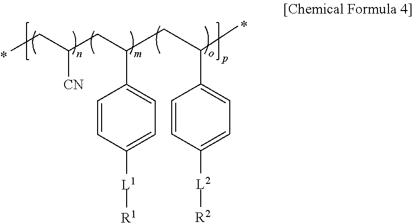

In Chemical Formula 4, n/(n+m+o) may range from 0.5 to 0.99 and (m+o)/(n+m+o) may range from 0.01 to 0.5, p may be an integer ranging from 10 to 10,000, L¹ and L² may be the same or different and are each independently —CR′R″—, —NR′—, —S—, —SO₂—, —O—, —C(O)O—, —NR′C(O)—, or a combination thereof, R′ and R″ may be the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, R¹ may be a hydrophilic or hydrophobic substituent, and R² may be a hydrophilic or hydrophobic substituent.

The copolymer may include a repeating unit represented by the following Chemical Formula 5.

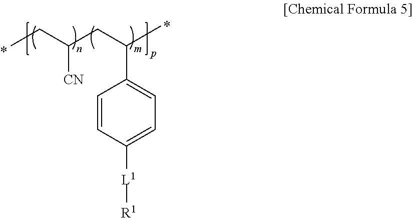

In Chemical Formula 5, n/(n+m) may range from 0.5 to 0.99 and m/(n+m) may range from 0.01 to 0.5, p may be an integer ranging from 10 to 10,000, L¹ may be —CR′R″—, —NR′—, —S—, —SO₂—, —O—, —C(O)O—, —NR′C(O)—, or a combination thereof, R′ and R″ may be the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, and R¹ may be a hydrophilic or hydrophobic substituent.

The hydrophilic substituent may include —OH, —SH, —NH₂, —COOH, —SO₃H, a halogen, salts thereof, or a combination thereof. The hydrophilic substituent may be a low molecular group, an oligomeric group, or a polymeric group.

The hydrophobic substituent may include a substituted or unsubstituted C1 to C10 alkyl group, a substituted or unsubstituted C5 to C30 aryl group, a fluorinated substituent thereof, fluoro group, or a combination thereof. The hydrophobic substituent may be a low molecular group, an oligomeric group, or a polymeric group.

According to another non-limiting embodiment of the disclosure, a method of manufacturing a membrane may include preparing a organic solution including a polyacrylonitrile-based copolymer, a pore-forming agent, and an organic solvent, applying the organic solution to a substrate, and precipitating the substrate applied with the organic solution in a non-solvent, wherein the polyacrylonitrile-based copolymer may be the above-described polyacrylonitrile-based copolymer.

The polyacrylonitrile-based copolymer, the pore-forming agent, and the organic solvent may be included in amounts of about 5 wt % to about 30 wt %, about 1 wt % to about 10 wt %, and about 60 wt % to about 94 wt %, respectively.

The substrate may be a glass plate or a polyester non-woven fabric.

The process of applying the organic solution to a substrate may be a process of coating the substrate with the organic solution to a thickness of about 100 μm to about 300 μm.

The pore-forming agent may include polyvinylpyrrolidone, polyethylene glycol, polyethyloxazoline, glycerol, ethylene glycol, diethylene glycol, ethanol, methanol, acetone, phosphoric acid, acetic acid, propanoic acid, lithium chloride, lithium nitrate, lithium perchlorate, or a combination thereof.

The organic solvent may include dimethyl formamide, dimethylsulfoxide, dimethylacrylamide, methylpyrrolidone, or a combination thereof.

According to another non-limiting embodiment of the disclosure, a membrane may include a polymer layer, and a support disposed on one side or both sides of the polymer layer. The support may include the above-described polyacrylonitrile-based copolymer.

The support may have a thickness of about 0.01 μm to about 500 μm.

The polymer layer may be a microfiltration membrane, an ultrafiltration membrane, a nanofiltration membrane, a reverse osmotic membrane, or a forward osmotic membrane.

According to another non-limiting embodiment of the disclosure, a water treatment module may include the membrane.

### BRIEF DESCRIPTION OF THE DRAWINGS

FIG. 1 illustrates a contact angle formed between the surface of a substrate and a droplet according to an example embodiment.

FIG. 2 shows data of contact angles of copolymers prepared according to Examples 1, 2, and 3 and a homopolymer prepared according to Comparative Example 1 with respect to water.

FIG. 3 is a SEM photograph showing a cross-section of a membrane formed according to Example 4.

FIG. 4 is a SEM photograph showing a cross-section of a membrane formed according to Example 5.

FIG. 5 is a SEM photograph showing a cross-section of a membrane formed according to Comparative Example 2.

### DETAILED DESCRIPTION

The disclosure will be described more fully hereinafter with reference to the accompanying drawings, in which various embodiments are shown. The disclosure may, however, be embodied in many different forms and is not to be construed as limited to the example embodiments set forth herein.

It will be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, e.g., “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms, “comprises,” “comprising,” “includes,” and/or “including,” if used herein, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As used herein, when a definition is not otherwise provided, the term “substituted” may refer to one substituted with a C1 to C30 alkyl group, a C1 to C10 alkylsilyl group, a C3 to C30 cycloalkyl group; a C6 to C30 aryl group, a C2 to C30 heteroaryl group, a C1 to C10 alkoxy group; a fluoro group, a C1 to C10 trifluoroalkyl group such as trifluoromethyl group, or a cyano group.

As used herein, when a definition is not otherwise provided, the term “hetero” may refer to a functional group including 1 to 3 heteroatoms selected from the group consisting of N, O, S, and P in conjunction with carbon atoms.

As used herein, when a definition is not otherwise provided, the term “combination thereof” refers to at least two substituents bound to each other by a linker, or at least two substituents condensed to each other.

As used herein, when a definition is not otherwise provided, the term “alkyl group” may refer to a “saturated alkyl group” without an alkene group or an alkyne group, or an “unsaturated alkyl group” including at least one of an alkene group or an alkyne group. The term “alkene group” may refer to a substituent in which at least two carbon atoms are bound with at least one carbon-carbon double bond, and the term “alkyne group” refers to a substituent in which at least two carbon atoms are bound with at least one carbon-carbon triple bond. The alkyl group may be a branched, linear, or cyclic group.

The alkyl group may be a C1 to C20 alkyl group, and more specifically a C1 to C6 lower alkyl group, a C7 to C10 intermediate alkyl group, or a C11 to C20 higher alkyl group.

For example, a C1-C4 alkyl may have 1 to 4 carbon atoms, and may be selected from the group consisting of methyl, ethyl, propyl, iso-propyl, n-butyl, iso-butyl, sec-butyl, and t-butyl.

The representative examples of an alkyl group may be selected from a methyl group, an ethyl group, a propyl group, an isopropyl group, a butyl group, an isobutyl group, a t-butyl group, a pentyl group, a hexyl group, an ethenyl group, a propenyl group, a butenyl group, a cyclopropyl group, a cyclobutyl group, a cyclopentyl group, a cyclohexyl group, or the like.

The term “aromatic group” may refer a substituent including a cyclic structure where all elements have p-orbitals which form conjugation. For example, an aryl group and a heteroaryl group may be utilized.

The term “aryl group” may refer to a monocyclic or fused ring-containing polycyclic (i.e., rings sharing adjacent pairs of carbon atoms) groups.

The “heteroaryl group” may refer to one including 1 to 3 heteroatoms selected from N, O, S, or P in an aryl group in conjunction with carbon atoms. When the heteroaryl group is a fused ring, each ring may include 1 to 3 heteroatoms.

The term “spiro structure” refers to a cyclic structure having a contact point of one carbon. Furthermore, the spiro structure may be used as a compound including the spiro structure or a substituent including the spiro structure.

In one non-limiting embodiment, a polyacrylonitrile-based copolymer may include a repeating unit represented by the following Chemical Formula 1, a repeating unit represented by the following Chemical Formula 2, and/or a repeating unit represented by the following Chemical Formula 3.

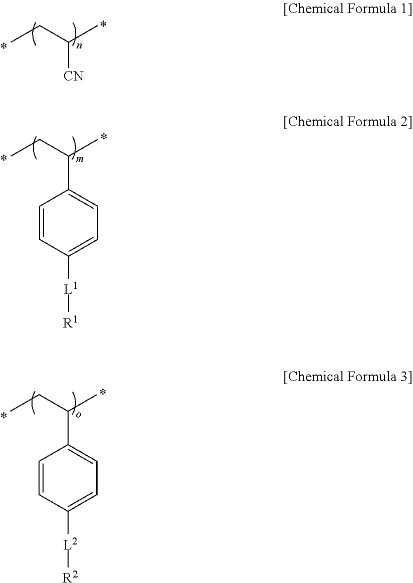

In Chemical Formulae 1 to 3, when the sum of n, m, and o is 1, n/(n+m+o) ranges from 0.5 to 0.99, and (m+o)/(n+m+o) ranges from 0.01 to 0.5, L¹ and L² are the same or different and are each independently —CR′R″—, —NR′—, —S—. —SO₂—, —O—, —C(O)O—, —NR′C(O)—, or a combination thereof, R′ and R″ are the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, R¹ is a hydrophilic or hydrophobic substituent, and R² is a hydrophilic or hydrophobic substituent.

Generally, a polyacrylonitrile homopolymer is known to have a desirable hydrophilic property. To manifest the hydrophilic property, a membrane is formed of polyacrylonitrile homopolymer and used as a substrate, and a method of measuring a contact angle by dropping a water droplet on the surface of the substrate may be used.

The term “contact angle” used in the present specification is defined as follows.

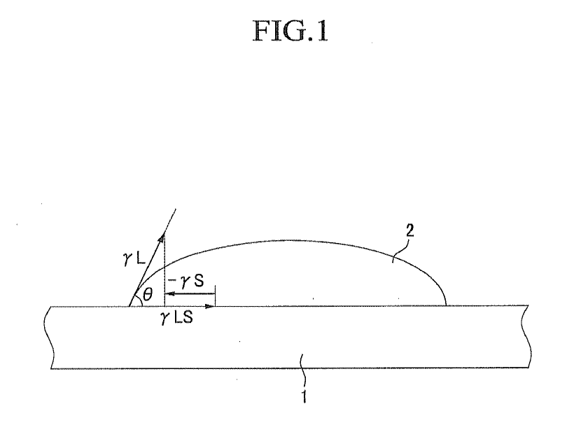

FIG. 1 illustrates a contact angle formed between the surface of a substrate and a droplet according to an example embodiment.

Generally, the shape of a bell-type droplet 2 existing on the surface of a substrate 1 may be defined as a contact angle (θ). The following Equation 1 (Young's Equation) is expressed in relation to the contact angle (θ), surface tension (γL) of a droplet, and surface energy (γS) of a substrate. In Equation 1, γLS denotes the interface energy between the surface of the substrate 1 and the droplet 2.

cos θ=(γS−γLS)/γL [Equation 1]

γLS decreases along with a decrease of γS, and when γS is decreased, it is generally known that the decrease amount of γLS is smaller than γS (e.g., refer to D. T. Kaelble, J. Adhesion, vol. 2 1970, pp. 66-81, the entire content of which is hereby incorporated by reference). Therefore, when the surface energy γS of the substrate 1 is decreased, the right side value of Equation 1 is decreased and the contact angle (θ) is increased. Therefore, the droplet 2 discharged onto the surface of the substrate 1 shrinks as time passes. Equation 1 may be represented by a vector as shown in FIG. 1.

In short, when the contact angle θ of the droplet 2 is relatively small, the droplet 2 is spread relatively widely on the substrate 1, which means that the substrate 1 and the droplet 2 have a chemical attraction for each other.

The contact angle θ of a polysulfone membrane with respect to water that is used for reverse osmosis is about 95°. On the other hand, the contact angle θ of a polyacrylonitrile membrane with respect to water is about 49°, which is more hydrophilic than a conventional membrane.

In a case of a polyacrylonitrile copolymer including a repeating unit represented by Chemical Formula 2 and/or 3, a small amount of hydrophobicity is given to the entire copolymer due to the presence of a phenylene group included in the repeating unit represented by Chemical Formula 2 and/or 3.

Also, the hydrophilicity and hydrophobicity of the entire copolymer may be adjusted by appropriately controlling the R¹ and R² substituents.

Controlling the hydrophilicity and hydrophobicity of the polyacrylonitrile copolymer as described above is a significant factor in relation to the water permeation amount of the membrane when a membrane is manufactured using the polyacrylonitrile copolymer.

For example, a membrane that may be generally used for a water treatment module may be a single membrane or a composite membrane, but the composite membrane may be more appropriate for a forward osmotic water treatment module.

The composite membrane that may be used for the forward osmosis may include a support and a polymer layer which substantially performs a separation function. The two membranes may be manufactured through interface polymerization.

Unlike reverse osmosis, the forward osmotic water treatment module does not use pressure. Therefore, the membrane water permeation amount of the membrane may be increased when the membrane is hydrophilic.

When both of the support and the polymer layer are hydrophilic, the water permeation amount of the membrane is expected to be theoretically desirable. However, when an actual composite membrane is formed, the hydrophilic support and the hydrophilic polymer layer cause a reaction with each other at the interface due to the characteristics of the hydrophilic support and the hydrophilic polymer layer, and non-uniformity increases at the interface. The increase of non-uniformity at the interface adversely affects the water permeation amount.

Therefore, in order to form a composite membrane having a relatively uniform interface, the hydrophilicity and hydrophobicity of the support need to be adjusted to an appropriate level.

The copolymer may have a weight average molecular weight of about 10,000 to about 200,000. When the weight average molecular weight falls in the above range, it is relatively easy to control a pore structure. When the weight average molecular weight is more than about 200,000, viscosity, which is an important factor for manufacturing a membrane, is increased and the formation of pores is adversely affected.

The copolymer may have polydispersity of about 1.0 to about 10.0. Within the range, the physical properties of the membrane may be reproduced with relative ease.

When the polydispersity is more than about 10, the distribution of molecular weight is so great that the pore structure, e.g., pore size, may be adversely affected.

The copolymer may include a repeating unit represented by the following Chemical Formula 4.

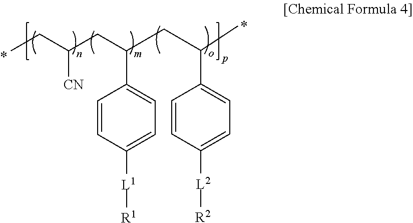

In Chemical Formula 4, n/(n+m+o) ranges from 0.5 to 0.99, and (m+o)/(n+m+o) ranges from 0.01 to 0.5, p is an integer ranging from 10 to 10,000, L¹ and L² are the same or different and are each independently —CR′R″—, —NR′—, —S—, —SO₂—, —O—, —C(O)O—, —NR′C(O)—, or a combination thereof, the R′ and R″ are the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, R¹ is a hydrophilic or hydrophobic substituent, and R² is a hydrophilic or hydrophobic substituent.

When a polyacrylonitrile copolymer is formed in the same order of the repeating unit represented by the above Chemical Formula 4, the merit of the polyacrylonitrile homopolymer is maintained, while the wettability of polyacrylonitrile is controlled with relative ease.

The copolymer may include a repeating unit represented by the following Chemical Formula 5.

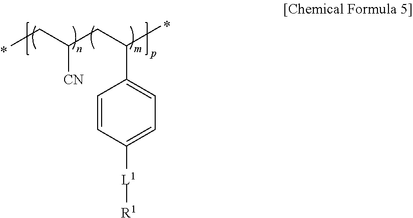

In Chemical Formula 5, n/(n+m) ranges from 0.5 to 0.99, and m/(n+m) ranges from 0.01 to 0.5, p is an integer ranging from 10 to 10,000, L¹ is —CR′R″—, —NR′—, —S—, —SO₂—, —O—, —C(O)O—, —NR′C(O)—, or a combination thereof, the R′ and R″ are the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, and R¹ is a hydrophilic or hydrophobic substituent.

It is relatively easy to control the substitution ratio of a hydrophilic or hydrophobic substituent, the weight average molecular weight, and the polydispersity of the polyacrylonitrile copolymer including the repeating unit represented by the above Chemical Formula 5, compared with the polyacrylonitrile copolymer including the repeating unit represented by the above Chemical Formula 4. Also, the polyacrylonitrile copolymer including the repeating unit represented by the above Chemical Formula 5 is more advantageous in terms of product yield and refining of a product than the polyacrylonitrile copolymer including the repeating unit represented by the above Chemical Formula 4.

The hydrophilic substituent may include —OH, —SH, —NH₂, —COOH, —SO₃H, a halogen, salts thereof, or a combination thereof, and the hydrophilic substituent may be a low molecular group, an oligomeric group, or a polymeric group. However, it should be understood that the disclosure is not limited thereto.

In addition, the low molecular group may have a molecular weight of about 1000 or less; the oligomeric group may have a molecular weight of about 1500 or less or a molecular weight of about 1000 to about 1500; and the polymeric group may have a weight average molecular weight of about 1500 to about 500,000, a weight average molecular weight of about 1500 to about 400,000, a weight average molecular weight of about 1500 to about 200,000, a weight average molecular weight of about 1500 to about 10,000, or a weight average molecular weight of about 10,000 to about 200,000.

The hydrophobic substituent may include a substituted or unsubstituted C1 to C10 alkyl group, a substituted or unsubstituted C5 to C30 aryl group, a fluorinated substituent thereof, fluoro group, or a combination thereof, and the hydrophobic substituent may be a low molecular group, an oligomeric group, or a polymeric group. However, it should be understood that the disclosure is not limited thereto.

In addition, the low molecular group may have a molecular weight of about 1000 or less; the oligomeric group may have a molecular weight of about 1500 or less or a molecular weight of about 1000 to about 1500; and the polymeric group may have a weight average molecular weight of about 1500 to about 500,000, a weight average molecular weight of about 1500 to about 400,000, a weight average molecular weight of about 1500 to about 200,000, a weight average molecular weight of about 1500 to about 10,000, or a weight average molecular weight of about 10,000 to about 200,000.

According to another non-limiting embodiment, a method of manufacturing a membrane may include preparing an organic solution including a polyacrylonitrile-based copolymer, a pore-forming agent, and an organic solvent, applying the organic solution to a substrate, and precipitating the substrate applied with the organic solution in a non-solvent. The polyacrylonitrile-based copolymer may be the above-described polyacrylonitrile-based copolymer.

The polyacrylonitrile-based copolymer, the pore-forming agent, and the organic solvent may be included in amounts of about 5 wt % to about 30 wt %, about 1 wt % to about 10 wt %, and about 60 wt % to about 94 wt %, respectively.

A membrane may be manufactured by using an organic solution composition including the polyacrylonitrile-based copolymer at about 5 wt % to about 30 wt %, the pore-forming agent at about 1 wt % to about 10 wt %, and the organic solvent at about 60 wt % to about 94 wt %. The range is appropriate for manufacturing the membrane through non-solvent induced phase separation (NIPS).

The non-solvent induced phase separation is a method for manufacturing a membrane by dissolving a polymer in a solvent and then impregnating it in a non-solvent. The method allows the manufacture of a membrane with relative ease at a relatively low production cost. The method may be applied to the manufacturing of diverse membranes.

Since the polyacrylonitrile-based copolymer is the same as the copolymer described earlier according to one non-limiting embodiment of the disclosure, further description thereof has been omitted herein.

The substrate may be a glass substrate or a polyester non-woven fabric, but the disclosure is not limited thereto.

The step of applying the organic solution to a substrate may be a step of applying the organic solution to the substrate at a thickness of about 100 μm to about 300 μm. The thickness range may be adjusted according to the desired thickness of a membrane.

The pore-forming agent may include polyvinylpyrrolidone, polyethylene glycol, polyethyloxazoline, glycerol, ethylene glycol, diethylene glycol, ethanol, methanol, acetone, phosphoric acid, acetic acid, propanoic acid, lithium chloride, lithium nitrate, lithium perchlorate, or a combination thereof, but is not limited thereto.

The organic solvent may include dimethyl formamide, dimethyl sulfoxide, dimethylacrylamide, methylpyrrolidone, or a combination thereof, but is not limited thereto.

The non-solvent is a general item that may be acquired relatively easily. For example, water may be the non-solvent because it is advantageous in terms of price.

According to another non-limiting embodiment of the disclosure, a membrane may include a polymer layer, and a support that includes a polyacrylonitrile-based copolymer prepared in accordance with a non-limiting embodiment of the disclosure and formed on one or both sides of the polymer layer.

The membrane may be manufactured in the form of a single layer by using the polyacrylonitrile-based copolymer prepared in accordance with a non-limiting embodiment of the disclosure, or the membrane may be manufactured in the form of a composite layer by using the polyacrylonitrile-based copolymer as a support and causing it to be bonded with a polymer layer.

As described above, when a forward osmotic water treatment module is used, the composite layer-type membrane may be more appropriate.

The support may have a thickness ranging from about 0.01 μm to about 500 μm. Within the range, not only may the water permeation amount be maintained, but also the membrane may have a proper hardness.

The polymer layer may be a microfiltration membrane, an ultrafiltration membrane, a nanofiltration membrane, a reverse osmotic membrane, or a forward osmotic membrane.

According to another non-limiting embodiment of the disclosure, a water treatment module may include a membrane manufactured according to a non-limiting embodiment of the disclosure.

The water treatment module may be based on forward osmosis, but the scope of the disclosure is not limited thereto.

A forward osmosis module is described hereafter by using desalination as an example.

Forward osmosis is a method of bringing a high-concentration inducing solute and sea water into contact with a semipermeable membrane between them to thereby make fresh water from the sea water to be absorbed into the inducing solute and then separating the fresh water out of the inducing solute.

A forward osmotic desalination is a process of inducing a flux of fresh water separated from the sea water into a high-concentration solution guided by an osmosis phenomenon existing between both sides of the membrane by using the inducing solute, and recycling the inducing solute in the diluted inducing solution by separation/concentration.

Hereinafter, various embodiments are illustrated in more detail with reference to the examples. However, it should be understood that the following are merely example embodiments and are not intended to be limiting.

### Preparation of Polyacrylonitrile-Based Copolymer

### Example 1

A polyacrylonitrile copolymer including a repeating unit represented by the following Chemical Formula 6 is prepared.

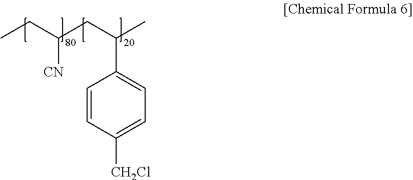

When it is assumed that the amount of acrylonitrile is about 20 g (376.9 mmol), the amount of chloromethylstyrene is about 15.47 g (94.2 mmol), and the amount of acrylonitrile and chloromethylstyrene is about 100 wt %, about 0.5 wt % of azobisisobutyronitrile (AIBN), which is a radical initiator, is put into refined tetrahydrofuran (THF) and the mixed solution is agitated at about 60° C. for about 24 hours.

The solution acquired after the agitation is cooled to room temperature, and a polymer is precipitated using a mixed solvent of ethanol and hexane mixed at a weight ratio of about 3:1. The precipitated polymer is sufficiently rinsed with methanol and water, and is dried to thereby obtain a polyacrylonitrile copolymer.

### Example 2

A polyacrylonitrile copolymer including a repeating unit represented by the following Chemical Formula 7 is prepared.

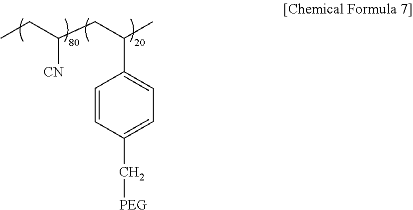

About 54.8 g (274 mmol) of polyethylene glycol (molecular weight: 200) and about 6.58 g (274 mmol) of sodium hydride are put into refined dimethyl acetamide (DMAc) to form a mixed solution. The mixed solution is heated at about 60° C.

A dimethyl acetamide solution in which about 20 g (274 mmol) of the polyacrylonitrile copolymerization derivative prepared according to Example 1 is dissolved is put into the mixed solution, and agitated in an atmosphere of nitrogen at a temperature of about 60° C. for about 24 hours. The solution obtained after the agitation is cooled to room temperature, and a polymer is precipitated using a mixed solvent of ethanol and hexane mixed at a weight ratio of about 3:1. The precipitated polymer is sufficiently rinsed with methanol and water, and is dried to thereby obtain a polyacrylonitrile copolymerization derivative having partially substituted polyethylene glycol in a side chain.

### Example 3

A polyacrylonitrile copolymer including a repeating unit represented by the following Chemical Formula 8 is prepared.

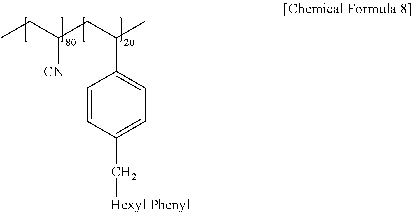

About 2.44 g (13.7 mmol) of hexylphenol and about 1.89 g (13.7 mmol) of potassium carbonate are put into refined dimethyl acetamide (DMAc) to form a mixed solution. The mixed solution is heated at about 60° C. A dimethyl acetamide solution in which about 1 g (13.7 mmol) of copolymerized polyacrylonitrile prepared according to Example 1 is dissolved is put into the mixed solution, and agitated in an atmosphere of nitrogen at a temperature of about 60° C. for about 24 hours. The solution obtained after the agitation is cooled to room temperature, and a polymer is precipitated using methanol. The precipitated polymer is sufficiently rinsed with methanol and water, and is dried to thereby obtain a copolymerized polyacrylonitrile derivative having partially substituted hexylphenol at a side chain.

### Comparative Example 1

A polyacrylonitrile homopolymer is used.

### Manufacturing Membrane

### Example 4

A membrane is manufactured using the polyacrylonitrile copolymer prepared according to Example 1.

A composition is prepared by dissolving about 5 g of the polyacrylonitrile copolymer prepared according to Example 1 in about 25.67 g of dimethyl formamide, and dissolving about 1.33 g of lithium chloride and about 1.33 g of polyvinylpyrrolidone. The prepared composition is poured onto a polyester non-woven fabric set onto a glass plate, and the coating liquid thickness is controlled by using a film applicator. Subsequently, a water treatment membrane including a polymer layer having a thickness of about 200 μm is manufactured by impregnating the filtration membrane coated with the coating liquid in an aqueous solution at room temperature for about 24 hours, and then drying it.

### Example 5

A membrane is manufactured according to the same method as Example 4, except that the polyacrylonitrile copolymer prepared according to Example 2 is used instead of the polyacrylonitrile copolymer prepared according to Example 1.

### Comparative Example 2

A membrane is manufactured according to the same method as Example 4, except that the polyacrylonitrile copolymer prepared according to Comparative Example 1 is used instead of the polyacrylonitrile copolymer prepared according to Example 1.

### Contact Angle of Polymer

The contact angles of the copolymers prepared according to Examples 1, 2, and 3 with respect to water and the contact angle of the homopolymer prepared according to Comparative Example 1 with respect to water are measured.

The contact angles are measured using distilled water as a wetting liquid. Specimens of the copolymers prepared according to Examples 1, 2, and 3 and Comparative Example 1 are prepared in a standard state and dried using a lyophilizer. The static contact angles are measured more than 5 times and an average value thereof is obtained.

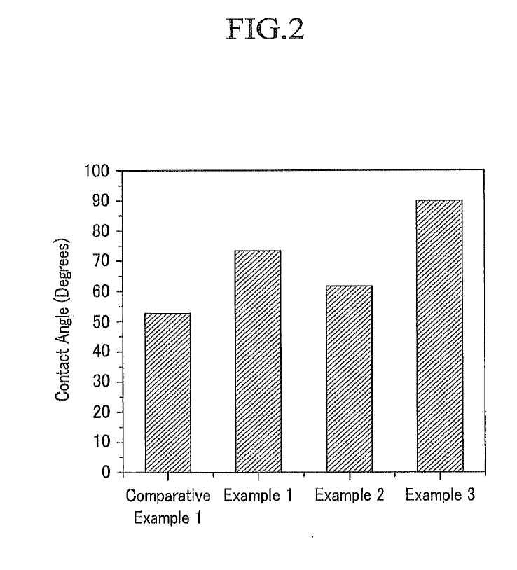

FIG. 2 shows data of the contact angles of the copolymers prepared according to Examples 1, 2, and 3 and the homopolymer prepared according to Comparative Example 1 with respect to water.

The contact angle of the copolymer prepared according to Example 1 averages about 73.7°. The contact angle of the copolymer prepared according to Example 2 averages about 61.8°. The contact angle of the copolymer prepared according to Example 3 averages about 93.0°.

On the other hand, the contact angle of the homopolymer prepared according to Comparative Example 1 averages about 53.2°. Thus, the copolymers prepared according to Examples 1, 2, and 3 are more hydrophobic than the homopolymer prepared according to Comparative Example 1.

### SEM Photograph of Membrane

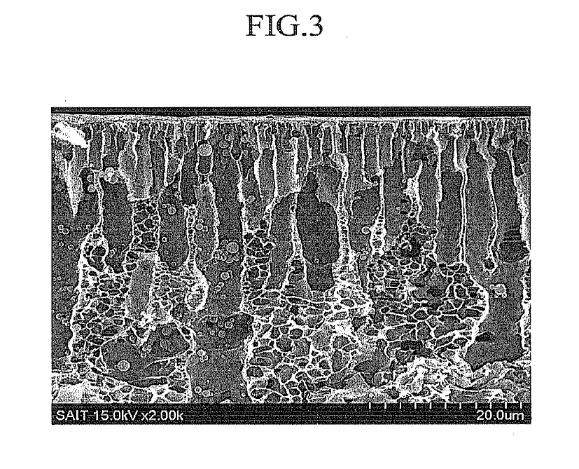

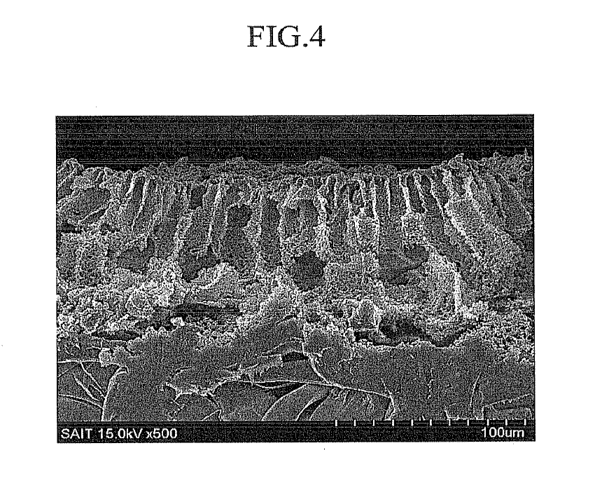

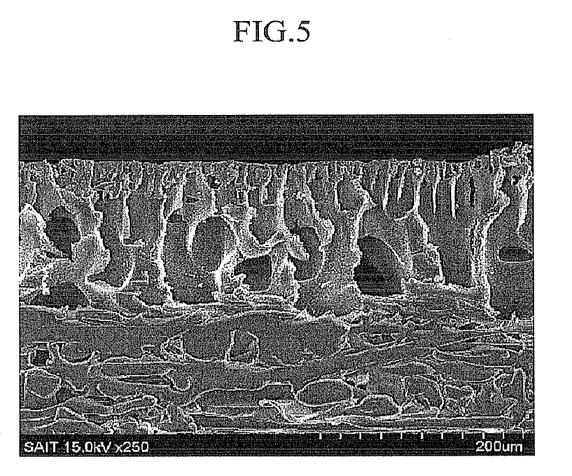

FIG. 3 is a SEM photograph showing a cross-section of the membrane formed according to Example 4. FIG. 4 is a SEM photograph showing a cross-section of the membrane formed according to Example 5. FIG. 5 is a SEM photograph showing a cross-section of the membrane formed according to Comparative Example 2.

It may be seen from the drawings that the thickness of the skin layer of the membrane manufactured according to Example 4 ranges from about 0.2 to about 0.4 μm, whereas the thickness of the skin layer of the membrane manufactured according to Comparative Example 2 ranges from about 4.5 to about 5 μm.

### Measurement of Water Permeation Amount of Manufactured Membrane

Water permeation amounts of the membrane manufactured according to Example 4 and the membrane manufactured according to Comparative Example 2 are measured.

The manufactured membrane is set in a cell having an effective area of about 600 cm² for measurement and compressed under a pressure of about 2 Kg/cm² for about 2 hours. The membrane is then measured under a pressure of about 1 Kg/cm².

The measurement values are presented in the following Table 1.

TABLE 1

| | | Water |
|---|---|---|
| | | permeation amount |
| | Polymer | (LMH) |
| Example 4 | Example 1 | 434 |
| Comparative Example 2 | Comparative Example 1 | 22 |

LMH denotes the amount of water passing per unit time, and L denotes the amount (liters) of water passing through the membrane, while M denotes the area (m²) of the membrane and H denotes passing time (hours). In short, it is an estimation unit for determining how many liters of water pass through the membrane of an area of 1 m² in one hour.

As shown in Table 1, the amount of water permeation of the membrane according to Example 4 is more than about 20 times that of the membrane according to Comparative Example 2.

While various example embodiments are disclosed herein, it should be understood that the scope of the disclosure is not limited to the disclosed embodiments, but, on the contrary, is intended to cover all modifications and equivalent arrangements included within the spirit and scope of the appended claims. Therefore, the aforementioned embodiments should be understood to be illustrative but not limiting to the disclosure in any way.

### DESCRIPTION OF SYMBOLS

1: substrate 2: droplet

What is claimed is:

1. A polyacrylonitrile-based copolymer comprising:
a repeating unit represented by Chemical Formula 1; and
at least one of a repeating unit represented by Chemical Formula 2 and a repeating unit represented by Chemical Formula 3: 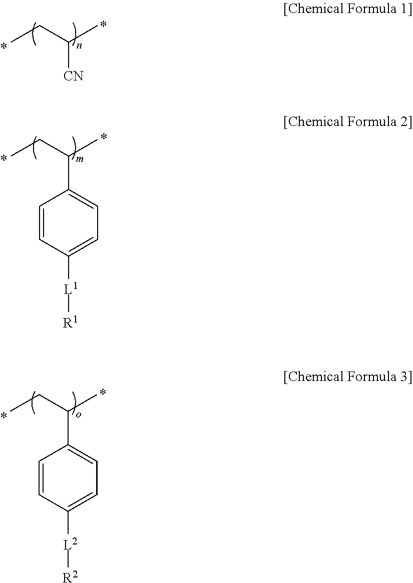
wherein, in Chemical Formulae 1 to 3, n/(n+m+o) ranges from 0.5 to 0.99 and (m+o)/(n+m+o) ranges from 0.01 to 0.5,
L¹ and L² are the same or different and are each independently —CR′R″—, —NR′—, —S—, —SO₂—, —O—, —C(O)O—, —NR′C(O)—, or a combination thereof,
R′ and R″ are the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof,
R¹ is a hydrophilic or hydrophobic substituent, and
R² is a hydrophilic or hydrophobic substituent.

2. The polyacrylonitrile-based copolymer of claim 1, wherein the copolymer has a weight average molecular weight of about 10,000 to about 200,000.

3. The polyacrylonitrile-based copolymer of claim 1, wherein the copolymer has a polydispersity of about 1.0 to about 10.0.

4. The polyacrylonitrile-based copolymer of claim 1, wherein the copolymer comprises a repeating unit represented by Chemical Formula 4: 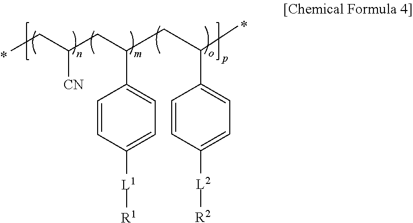
wherein, in Chemical Formula 4,
n/(n+m+o) ranges from 0.5 to 0.99 and (m+o)/(m+n+o) ranges from 0.01 to 0.5,
p is an integer ranging from 10 to 10,000,
L¹ and L² are the same or different and are each independently —CR′R″—, —NR′—, —S—, —SO₂—, —O—, —C(O)O—, —NR′C(O)—, or a combination thereof,
R′ and R″ are the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof,
R¹ is a hydrophilic or hydrophobic substituent, and
R² is a hydrophilic or hydrophobic substituent.

5. The polyacrylonitrile-based copolymer of claim 1, wherein the copolymer comprises a repeating unit represented by Chemical Formula 5: 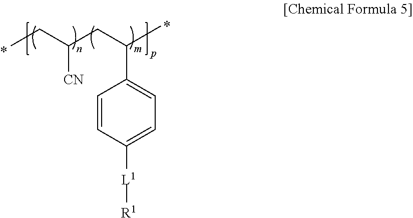
wherein, in Chemical Formula 5,
n/(n+m) ranges from 0.5 to 0.99 and m/(n+m) ranges from 0.01 to 0.5,
p is an integer ranging from 10 to 10,000,
L¹ is —CR′R″—, —NR′—, —S—, —SO₂—, —O—, —C(O)O—, —NR′C(O)—, or a combination thereof,
R′ and R″ are the same or different and are each independently hydrogen, deuterium, a substituted or unsubstituted C1 to C10 alkyl group, a substituted or unsubstituted C6 to C30 aryl group, a substituted or unsubstituted C3 to C30 heteroaryl group, a halogen, or a combination thereof, and
R¹ is a hydrophilic or hydrophobic substituent.

6. The polyacrylonitrile-based copolymer of claim 1, wherein
the hydrophilic substituent comprises —OH, —SH, —NH₂, —COOH, —SO₃H, a halogen, salts thereof, or a combination thereof, and
the hydrophilic substituent is a low molecular group, an oligomeric group, or a polymeric group.

7. The polyacrylonitrile-based copolymer of claim 1, wherein the hydrophobic substituent comprises a substituted or unsubstituted C1 to 010 alkyl group, a substituted or unsubstituted C5 to C30 aryl group, a fluorinated substituent thereof, fluoro group, or a combination thereof, and
the hydrophobic substituent is a low molecular group, an oligomeric group, or a polymeric group.

8. A method of manufacturing a membrane, comprising:
preparing an organic solution including a polyacrylonitrile-based copolymer, a pore-forming agent, and an organic solvent;
applying the organic solution to a substrate; and
precipitating the substrate applied with the organic solution in a non-solvent,
wherein the polyacrylonitrile-based copolymer is the polyacrylonitrile-based copolymer of claim 1.

9. The method of claim 8, wherein the preparing an organic solution includes adding the polyacrylonitrile-based copolymer, the pore-forming agent, and the organic solvent in an amount of about 5 wt % to about 30 wt %, about 1 wt % to about 10 wt %, and about 60 wt % to about 94 wt %, respectively.

10. The method of claim 8, wherein the applying the organic solution includes applying the organic solution to a substrate that comprises a glass plate or a polyester non-woven fabric.

11. The method of claim 8, wherein the applying the organic solution includes applying the organic solution to a thickness of about 100 μm to about 300 μm on the substrate.

12. The method of claim 8, wherein the preparing an organic solution includes adding a pore-forming agent that comprises polyvinylpyrrolidone, polyethylene glycol, polyethyloxazoline, glycerol, ethylene glycol, diethylene glycol, ethanol, methanol, acetone, phosphoric acid, acetic acid, propanoic acid, lithium chloride, lithium nitrate, lithium perchlorate, or a combination thereof.

13. The method of claim 8, wherein the preparing an organic solution includes adding an organic solvent that comprises dimethyl formamide, dimethylsulfoxide, dimethylacrylamide, methylpyrrolidone, or a combination thereof.

14. A membrane comprising:
a polymer layer; and
a support including a polyacrylonitrile-based copolymer, the support disposed on at least one side of the polymer layer, the support including the polyacrylonitrile-based copolymer of claim 1.

15. The membrane of claim 14, wherein the support has a thickness of about 0.01 μm to about 500 μm.

16. The membrane of claim 14, wherein the polymer layer is a microfiltration membrane, an ultrafiltration membrane, a nanofiltration membrane, a reverse osmotic membrane, or a forward osmotic membrane.

17. A water treatment module comprising the membrane of claim 14.
